(19) United States
(12) Patent Application Publication
(10) Pub. No.: US 2016/0217811 A1
(43) Pub. Date: Jul. 28, 2016

(54) BIO-DISC DETECTION DEVICE

(71) Applicant: QUANTA STORAGE INC., Taoyuan City (TW)

(72) Inventors: Chen-Fu CHANG, Taoyuan City (TW); Yu-Sheng WANG, Taoyuan City (TW); Chien-Hui HSU, Taoyuan City (TW); Hsien-Chung OU, Taoyuan City (TW)

(73) Assignee: QUANTA STORAGE INC., Taoyuan City (TW)

(21) Appl. No.: 14/731,118

(22) Filed: Jun. 4, 2015

(30) Foreign Application Priority Data
Jan. 22, 2015 (CN) 201510031626.3

(51) Int. Cl. G11B 5/012; G11B 7/13; G11B 7/1362; G11B 7/08

(52) U.S. Cl. CPC G11B 5/012; G11B 7/083; G11B 7/13; G11B 7/1362; G11B 2005/0005

(57) ABSTRACT

A bio-disc detection device is provided. A spindle motor is disposed on a chassis for rotating a bio-disc. The bio-disc has a detection groove disposed thereon. The chassis has an optical pick-up head disposed thereon for emitting a light beam to irradiate the detection groove. A receiver receives a light flux passing through the detection groove. A magnetic field generator generates a magnetic field which uniformly covers the detection groove. The chassis has a bracket disposed thereon for fixing the receiver and the magnetic field generator, such that the receiver, the magnetic field generator, the spindle motor and the optical pick-up head are fixed on the chassis of the same foundation member.

This application claims the benefit of People's Republic of China application Serial No. 201510031626.3, filed on Jan. 22, 2015, the subject matter of which is incorporated herein by reference.

### BACKGROUND OF THE INVENTION

1. Field of the Invention

The invention relates in general to a bio-disc detection device, and more particularly to an optical detection device using the magnetic force generated by a magnetic field generator to absorb the bio-particles carried on the bio-disc for detecting the bio-particles.

2. Description of the Related Art

Along with the rapid advance in medical technology, precision bio-detection technology is continually provided. The optical bio-disc detection technology for detecting bio-particles is capable of detecting pleural bio-samples on the bio-disc and automatically and quickly analyzing the samples, and therefore has become a key technology used in medical detection.

According to the bio-disc detection device of the prior art, such as the U.S. Pat. No. 7,639,359, the bio-disc has pleural test channels disposed thereon for loading a bio-sample such as blood and an agent with specific mark such as magnetic beads. Then, the spindle motor is activated to rotate the bio-disc at a high speed, such that the bio-disc rotated at a high speed generates a centrifugal force for enabling the bio-sample and the agent to enter the detection groove of the test channel and mix together. A magnetic field with low intensity absorbs the bio-particles with low magnetism (such as pathogens) located in the detection groove. An optical pick-up head emits a light beam to irradiate the detection groove, and the amount of magnetic bio-particles in the detection groove affects the light flux passing through the detection groove. A receiver receives the light flux passing through the detection groove. Then, the light flux optical pick-up head converts the amount of the light flux into signals with relative intensities for detection analysis of pathogens.

According to the prior art, when the optical pick-up head of the bio-disc detection device emits a light beam, the optical pick-up head must face the detection groove otherwise the light beam might be scattered. The low magnetism of the magnetic field must be uniform so as to attract the pathogens with weak magnetism in the detection groove, and the receiver must correctly cover the light flux passing through the detection groove to avoid the light flux not being received. These are two key factors for maintaining precision detection of the bio-disc detection device. The accuracy in the disposition of the optical pick-up head, the magnetic field generator and the receiver with respect to the detection groove and assembly error directly affect the analysis of bio-disc detection.

According to the prior art, detection components such as the optical pick-up head, the magnetic field generator and the receiver are disposed within the bio-disc detection device but are disposed on different foundation member of the bio-disc detection device. Since the detection components are disposed on different foundation members, assembly error may easily occur, the foundation members may vibrate and change relative positions of the detection components. Consequently, the accuracy in bio-disc detection is decreased. Therefore, the disposition of detection components of the bio-disc detection device still has many problems to resolve.

### SUMMARY OF THE INVENTION

According to one embodiment of the present invention, a bio-disc detection device is provided. An optical pick-up head, a magnetic field generator and a receiver are disposed on the same foundation member, such that assembly error and relative offset can both be reduced.

According to another embodiment of the present invention, a bio-disc detection device is provided. An isolation member is disposed on the foundation member to isolate vibration, so that vibration coming from outside the casing will not be transmitted to the foundation member, and relative offset generated by the optical pick-up head, the magnetic field generator and the receiver with respect to the bio-disc can be reduced, and accuracy of detection may be increased.

To achieve the above objects, the bio-disc detection device of the present invention has following arrangements. The chassis is fixed within the casing. The spindle motor is disposed on the chassis for providing a power to rotate the bio-disc. The bio-disc has a plurality of test channels and a detection groove disposed thereon. The chassis further has an optical pick-up head disposed thereon for emitting a light beam to irradiate the detection groove. The receiver is suspended on the other side of the bio-disc opposite to the optical pick-up head for receiving a light flux which is emitted by the optical pick-up head and passes through the detection groove. The field generator with magnetism is suspended on two sides of the detection groove. The chassis has a bracket disposed thereon for fixing the receiver and the magnetic field generator, such that the receiver, the magnetic field generator, the spindle motor and the optical pick-up head are fixed on the chassis of the same foundation member.

The bio-disc detection device of the present invention has an optical pick-up head guided by a pair of guide rods disposed on the chassis in parallel to slide along the radial direction of the bio-disc to adjust the position for irradiating the detection groove. The receiver is a reflective mirror which reflects the light flux passing through the detection groove such that the reflected light flux is received by the optical pick-up head. The receiver can also be realized by a sensor disposed outside the magnetic field generator for directly receiving and converting the light flux passing through the detection groove into signals and transmitting the signals to the bio-disc detection device for detection analysis.

The bio-disc detection device of the present invention has a magnetic field generator formed of an upper magnetic ring and a lower magnetic ring respectively suspended on two sides of the detection groove. The magnetic field generator generates a magnetic field uniformly covering the detection groove. An isolation member is disposed on the bottom side of the chassis such that the chassis is fixed on the casing through the isolation member. The isolation member is formed of a shock absorbing material and isolates the vibration coming from outside the casing.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a top view of a bio-disc detection device according to an embodiment of the invention;

FIG. 2 is a side view of a bio-disc detection device according to an embodiment of the invention;

FIG. 3 is a schematic diagram of a magnetic field generator according to an embodiment of the invention;

FIG. 4 is a top view of a bio-disc detection device according to another embodiment of the invention; and

FIG. 5 is a side view of a bio-disc detection device according to another embodiment of the invention.

### DETAILED DESCRIPTION OF THE INVENTION

The technologies adopted to achieve the objects of the invention and the effects thereof are disclosed below in a number of preferred embodiments with accompanying drawings.

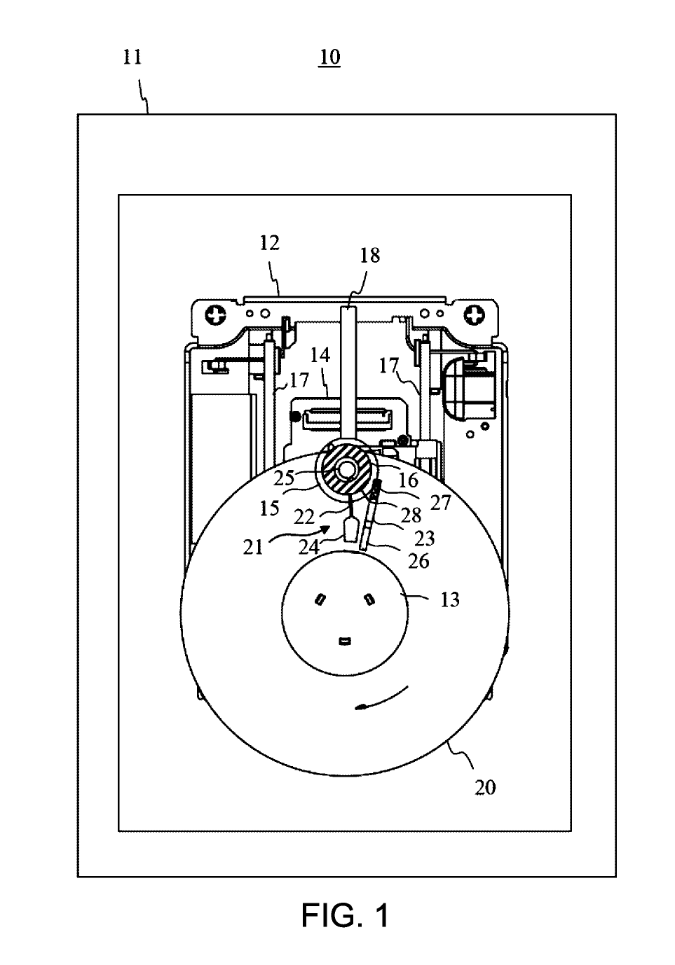

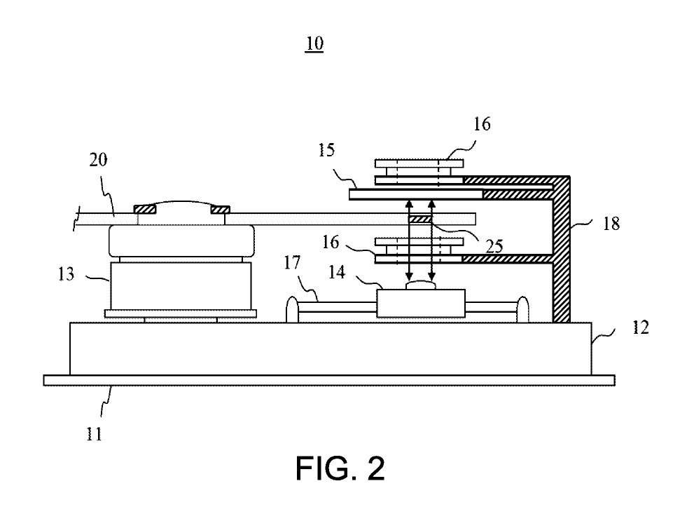

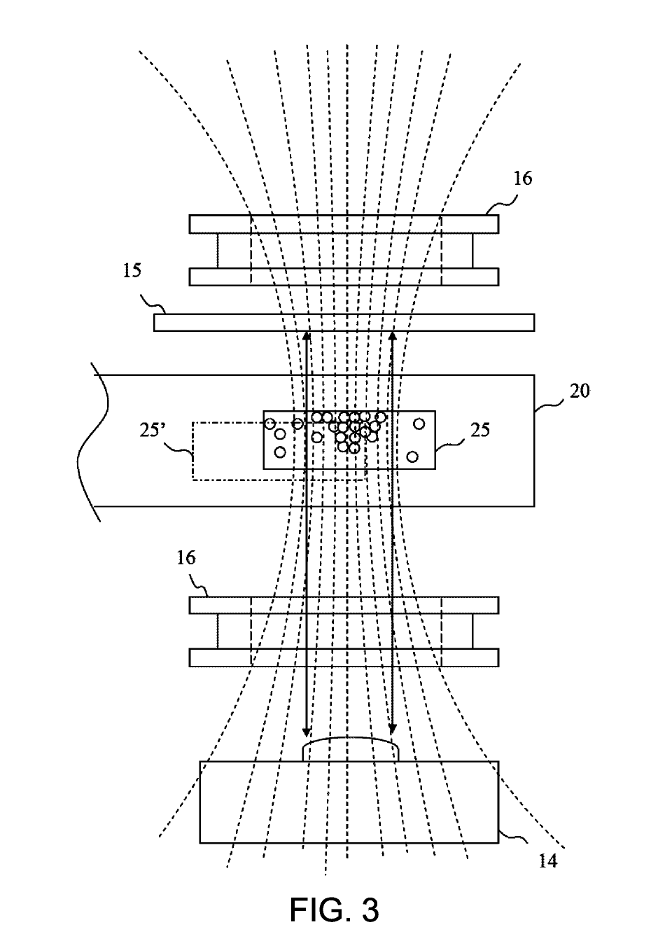

Refer to FIG. 1, FIG. 2 and FIG. 3. FIG. 1 is a top view of a bio-disc detection device according to an embodiment of the invention. FIG. 2 is a side view of a bio-disc detection device according to an embodiment of the invention. FIG. 3 is a schematic diagram of a magnetic field generator according to an embodiment of the invention. In the present invention, the bio-disc detection device 10 is disposed within the casing 11 and mainly includes a chassis 12, a spindle motor 13, an optical pick-up head 14, a receiver 15 and a magnetic field generator 16. The chassis 12 is fixed on the casing 11. The spindle motor 13 is disposed on the chassis 12. The shaft of the spindle motor 13 is mounted in the central hole of the bio-disc 20. The spindle motor 13 provides a power for rotating the bio-disc 20 at a high speed.

The bio-disc 20 has pleural test channels 21 disposed thereon. Each test channel 21 has an agent channel 22 and a sample channel 23 for loading a bio-sample and an agent. The inlet 24 of the agent channel 22 is disposed at the inner side of the bio-disc 20, and the terminal end of the agent channel 22 has a detection groove 25 disposed at the outer side of the bio-disc 20. The inlet 26 of the sample channel 23 is disposed at the inner side of the bio-disc 20, and the terminal end of the sample channel 23 has a separation groove 27 disposed at the outer side of the bio-disc 20. The separation groove 27 is connected to the detection groove 25 via a micro-valve conduit 28.

The chassis 12 has an optical pick-up head 14 disposed opposite to the radial position of the detection groove 25 of the bio-disc 20. The optical pick-up head 14 emits a parallel beam to irradiate the detection groove 25 of the bio-disc 20. The optical pick-up head 14 is guided by a pair of guide rods 17 disposed on the chassis 12 in parallel to slide along the radial direction of the bio-disc 20 to adjust the position for irradiating the detection groove 25. The chassis 12 further has a bracket 18 disposed thereon for fixing the receiver 15 and the magnetic field generator 16, such that the receiver 15 is suspended on the other side of the bio-disc 20 opposite to the optical pick-up head 14. The receiver 15 receives a light flux which is emitted by the optical pick-up head 14 and passes through the detection groove 25. In an embodiment of the present, the receiver 15 is realized by a reflective mirror, which reflects the light flux passing through the detection groove 25 such that the reflected light flux is received the optical pick-up head 14.

The magnetic field generator 16 fixed by the bracket 18 can be realized by an upper magnetic ring and a lower magnetic ring formed of a permanent magnet or an electromagnet. The upper magnetic ring and the lower magnetic ring are respectively suspended on two sides of the detection groove 25 of the bio-disc 20, such that the magnetic field generated by the upper magnetic ring and the lower magnetic ring of the magnetic field generator 16 uniformly covers the detection groove 25. In the present invention, the spindle motor 13 is fixed on the chassis 12 for rotating the bio-disc 20, the optical pick-up head 14 is fixed on the chassis 12, the receiver 15 and the magnetic field generator 16 are fixed by the bracket 18 extended from the chassis 12. The spindle motor 13, the optical pick-up head 14, the receiver 15 and the magnetic field generator 16 all are fixed on the chassis 12, so that main detection components of the present invention can be fixed on the same foundation member.

When the bio-disc detection device 10 of the present invention detects a bio-sample, firstly, a bio-disc 20 is installed. In the present embodiment, the bio-sample is exemplified by blood and the agent is exemplified by magnetic beads. However, the bio-sample is not limited to blood. Then, the blood is infused to the inlet 26 of the sample channel 23 of the test channel 21, and the agent is infused to the inlet 24 of the agent channel 22. Then, the spindle motor 13 is activated to rotate the bio-disc 20 at a high speed, and the bio-disc 20 rotated at a high speed generates a centrifugal force for separating the bio-sample. When receiving the centrifugal force, the blood and the agent located at the inner side of the bio-disc 20 flow to the outer side of the bio-disc 20 along the sample channel 23 and the agent channel 22, respectively. The agent flows to the detection groove 25. As for the blood containing plasma and blood cells, the blood cells are heavier than the plasma, and are therefore separated from the plasma by the centrifugal force. The blood cells enter the separation groove 27 at the terminal end of the sample channel 23, and the plasma is retained in the middle segment of the sample channel 23 and continues to receive the centrifugal force for opening the micro-valve conduit 28 to enter the detection groove 25 and mix with the agent which already enters the detection groove 25. Therefore, in the plasma, specific particles, such as pathogens, form bio-particles with low magnetism.

Then, a detection process is performed. The bio-disc 20 is rotated by the spindle motor 13 at a low speed, such that each detection groove 25 disposed on the bio-disc 20 will be temporarily halted or pass through a predetermined position at a predetermined speed of rotation, the optical pick-up head 14 is controlled to emit a parallel beam, and the position of the optical pick-up head 14 is adjusted to move along the radial direction of the guide rod 17 to correctly irradiate the detection groove 25 passing through a predetermined position. Meanwhile, the magnetic field generator 16 is activated to generate a magnetic field. As indicated in FIG. 3, the magnetic field generated by the magnetic field generator 16 uniformly passes through the detection groove 25, and the magnetic force attracts and concentrates bio-particles such as pathogens with low magnetism on the path of the parallel beam emitted by the optical pick-up head 14. The amount of magnetic bio-particles affects the light flux passing through the detection groove 25. Then, the reflective mirror of the receiver 15 receives a light flux passing through the detection groove 25 and further reflects the light flux to the optical pick-up head 14. The optical pick-up head 14 converts the amount of the light flux into signals with relative intensities and further transmits the signals to the bio-disc detection device 10 for detection analysis of pathogens.

As long as any detection component such as the bio-disc detection device 10, such as the spindle motor 13, the optical pick-up head 14, the receiver 15 or the magnetic field generator 16 generates offset with respect to the detection groove 25′ of FIG. 3, the light beam emitted by the optical pick-up head 14 will be incapable of correctly passing through the detection groove 25 to be concentrated on the path of the magnetic bio-particles, the receiver 15 will be incapable of correctly reflecting the light flux passing through the detection groove, and the magnetic field generator 16 will be incapable of concentrating the magnetic bio-particles on the path of the light beam. Thus, the detection analysis of the bio-disc will be affected. In the present invention, main detection components of the bio-disc detection device 10, such as the spindle motor 13, the optical pick-up head 14, the receiver 15 and the magnetic field generator 16, are fixed on the chassis 12 of the same foundation member, not only reducing assembly error but also reducing relative offset. Since the main detection components move together with the foundation member, the main detection components of the present invention remain on the same relative positions and face towards the detection groove 25, and relative offset can thus be reduced.

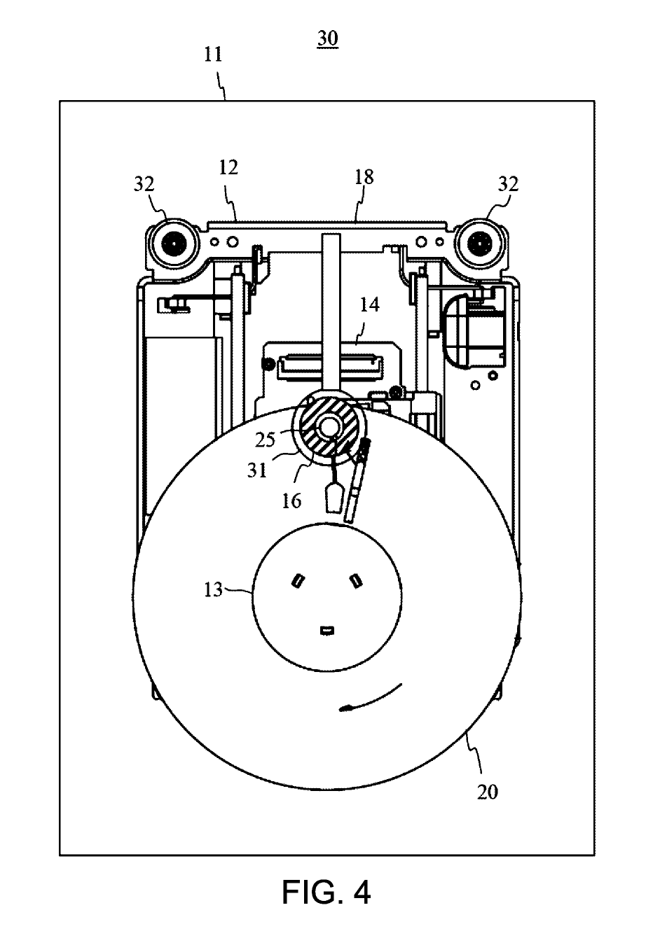

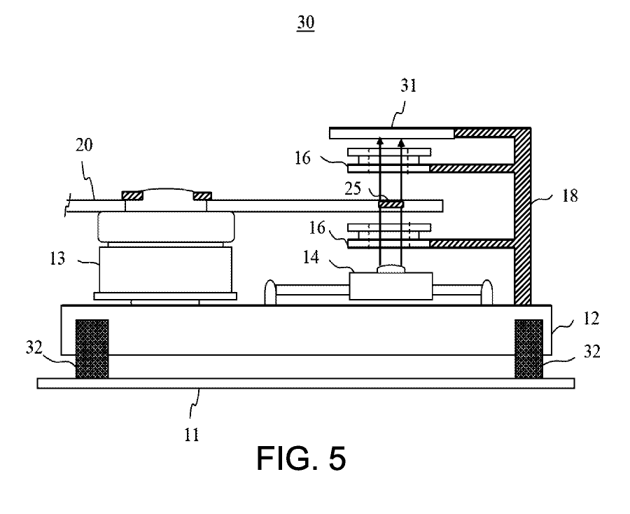

Refer to FIG. 4 and FIG. 5. FIG. 4 is a top view of a bio-disc detection device 30 according to another embodiment of the invention. FIG. 5 is a side view of a bio-disc detection device 30 according to another embodiment of the invention. The basic structure of the bio-disc detection device 30 of the present embodiment is different from that of the bio-disc detection device of previous embodiment merely in the receiver 31 and the isolation member 32. To simplify the description, the same reference numerals are used for elements common to above embodiments. In the present invention, the receiver 31 of the bio-disc detection device 30 is realized by a sensor, and is disposed outside the magnetic field generator 16. The optical pick-up head 14 emits a light beam to irradiate the detection groove 25. The light flux passing through the detection groove 25 is directly received by the receiver 31 (realized by such as a sensor fixed on the bracket 18), converted into signals with relative intensities, and transmitted to the bio-disc detection device 30 through a transmission path embedded in the bracket 18 (not illustrated) for detection analysis. Thus, the bio-disc detection device 30 can be simplified.

In addition, in the bio-disc detection device 30 of the present embodiment, an isolation member 32 is disposed on the bottom side of the chassis 12, such that the chassis 12 is fixed on the casing 11 through the isolation member 32. The isolation member 32, formed of a shock absorbing material, isolates the vibration coming from outside the casing 11 to avoid the chassis 12 vibrating and at the same time provides shock absorption to main detection components fixed on the chassis 12, such as the spindle motor 13, the optical pick-up head 14, the receiver 31 and the magnetic field generator 16. The isolation member 32 also reduces the deflection of the rotated bio-disc 20 and avoids the detection groove 25 being deflected off the detection path.

The bio-disc detection device of the present invention has an isolation member disposed on the chassis of the foundation member to isolate vibration, so that vibration coming from outside the casing will not be transmitted to the foundation member, and relative offset generated by the optical pick-up head, the magnetic field generator and the receiver with respect to the bio-disc can be reduced. Therefore, the bio-disc detection device of the present invention can increase detection accuracy.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A bio-disc detection device disposed within a casing and comprising:
a chassis fixed on the casing;
a spindle motor disposed on the chassis for providing a power to rotate the bio-disc, wherein the bio-disc has a plurality of test channels and a detection groove disposed thereon;
an optical pick-up head disposed on the chassis for emitting a light beam to irradiate the detection groove;
a receiver suspended on the other side of the bio-disc opposite to the optical pick-up head for receiving a light flux which is emitted by the optical pick-up head and passes through the detection groove;
a magnetic field generator suspended on two sides of the detection groove;
wherein the chassis has a bracket disposed thereon for fixing the receiver and the magnetic field generator, such that the receiver, the magnetic field generator, the spindle motor and the optical pick-up head are fixed on the chassis of the same foundation member.

2. The bio-disc detection device according to claim 1, wherein the optical pick-up head is guided by a pair of guide rods disposed on the chassis in parallel to slide along a radial direction of the bio-disc to adjust a position for irradiating the detection groove.

3. The bio-disc detection device according to claim 1, wherein the receiver is a reflective mirror which reflects the light flux passing through the detection groove such that the reflected light flux is received by the optical pick-up head.

4. The bio-disc detection device according to claim 1, wherein the receiver is a sensor, which directly receives and converts the light flux passing through the detection groove into signals and further transmits the signals to the bio-disc detection device for detection analysis.

5. The bio-disc detection device according to claim 4, wherein the receiver is disposed outside the magnetic field generator.

6. The bio-disc detection device according to claim 1, wherein the magnetic field generator comprises an upper magnetic ring and a lower magnetic ring respectively suspended on two sides of the detection groove, and generates a magnetic field uniformly covering the detection groove.

7. The bio-disc detection device according to claim 1, wherein the chassis has an isolation member disposed thereon, such that the chassis is fixed on the casing through the isolation member.

8. The bio-disc detection device according to claim 7, wherein the isolation member is fixed on a bottom side of the chassis.

9. The bio-disc detection device according to claim 7, wherein the isolation member is a shock absorbing material and isolates the vibration coming from outside the casing.

10. The bio-disc detection device according to claim 1, wherein the bracket is integrally extended from the chassis.
